(19) United States
(12) Patent Application Publication
(10) Pub. No.: US 2026/0030215 A1
(43) Pub. Date: Jan. 29, 2026

(54) Data Storage Device and Method for Providing an Efficient Multitenancy Arrangement in High-Capacity Data Storage Devices

(71) Applicant: Sandisk Technologies, Inc., Milpitas, CA (US)

(72) Inventors: Amit Sharma, Bangalore (IN); Dinesh Kumar Agarwal, Bangalore (IN)

(73) Assignee: Sandisk Technologies, Inc., Milpitas, CA (US)

(21) Appl. No.: 18/783,863

(22) Filed: Jul. 25, 2024

(51) Int. Cl. G06F 16/176; G06F 16/18

(52) U.S. Cl. CPC G06F 16/176; G06F 16/1847

(57) ABSTRACT

A data storage device and method are disclosed for providing an efficient multitenancy arrangement in high-capacity data storage devices. In one embodiment, a data storage device is provided comprising a memory and one or more processors. The one or more processors, individually or in combination, are configured to: create a plurality of metadies, wherein each metadie comprises a different subset of memory dies of the plurality of memory dies; determine which tenants of the data storage device are frequently used together; assign the tenants that are frequently used together to a same metadie; and access memory dies of the same metadie in parallel in response to an access request from one of the tenants that is assigned to the same metadie. Other embodiments are provided.

### BACKGROUND

A data storage device can have multiple memory dies. If the data storage device has a relatively-small number of memory dies, all of the memory dies can be logically grouped together as a “metadie” and operated in parallel. However, if the data storage device has a relatively-large number of memory dies, power or resource limitations may prohibit all of the memory dies from being grouped together as a single metadie. In such situations, the memory dies can be logically grouped together in multiple memory dies.

### BRIEF DESCRIPTION OF THE DRAWINGS

FIG. 1A is a block diagram of a data storage device of an embodiment.

FIG. 1B is a block diagram illustrating a storage module of an embodiment.

FIG. 1C is a block diagram illustrating a hierarchical storage system of an embodiment.

FIG. 2A is a block diagram illustrating components of the controller of the data storage device illustrated in FIG. 1A according to an embodiment.

FIG. 2B is a block diagram illustrating components of the data storage device illustrated in FIG. 1A according to an embodiment.

FIG. 3 is a block diagram of a host and a data storage device of an embodiment.

FIG. 4 is an illustration of multiple metadies of a data storage device of an embodiment.

FIG. 5 is an illustration of three tenants accessing multiple metadies of a data storage device of an embodiment.

FIG. 6 is an illustration of two tenants accessing different metadies of a data storage device of an embodiment.

FIG. 7 is an illustration of two tenants accessing the same metadie of a data storage device of an embodiment.

FIG. 8 is a diagram of a host and a data storage device of an embodiment.

### DETAILED DESCRIPTION

The following embodiments generally relate to a data storage device and method for providing an efficient multitenancy arrangement in high-capacity data storage devices. In one embodiment, a data storage device is provided comprising a memory and one or more processors. The one or more processors, individually or in combination, are configured to: create a plurality of metadies, wherein each metadata comprises a different subset of memory dies of the plurality of memory dies; determine which tenants of the data storage device are frequently used together; assign the tenants that are frequently used together to a same metadie; and access memory dies of the same metadie in parallel in response to an access request from one of the tenants that is assigned to the same metadie.

In some embodiments, assigning tenants of the plurality of tenant that are frequently used together to the same metadie avoids metadie switching and allows only one metadie to be used at any point in time.

In some embodiments, the one or more processors, individually or in combination, are further configured to determine which tenants are frequently used together by receiving tenant grouping information from a host.

In some embodiments, the host is configured to create the tenant grouping information when the host creates the tenants.

In some embodiments, the host is configured to create the tenant grouping information over time as the host observes which tenants are frequently used together.

In some embodiments, the one or more processors, individually or in combination, are further configured to receive updated tenant grouping information from the host.

In some embodiments, the one or more processors, individually or in combination, are further configured to determine which tenants are frequently used together by observing tenant usage.

In some embodiments, the one or more processors, individually or in combination, are further configured to consolidate pre-programmed data into one of the plurality of metadies.

In some embodiments, a power limitation prohibits all of the memory dies of the plurality of memory dies from being grouped together as a single metadie.

In some embodiments, a resource limitation prohibits all of the memory dies of the plurality of memory dies from being grouped together as a single metadie.

In some embodiments, the plurality of memory dies comprises at least 16 memory dies.

In some embodiments, the plurality of memory dies comprises at least 32 memory dies.

In some embodiments, the plurality of memory dies comprises at least 64 memory dies.

In some embodiments, the plurality of memory dies comprises at least 128 memory dies.

In some embodiments, at least one memory die of the plurality of memory dies comprises a three-dimensional memory.

In another embodiment, a method is provided that is performed in a data storage device comprising a plurality of memory dies organized into a plurality of metadies. The method comprises: identifying users that use the data storage device together more than a threshold number of times; associating the users with a same metadie; and accessing memory dies of the same metadie in parallel in response to an access request from one of the users associated with the same metadie.

In some embodiments, identifying the users comprises receiving user grouping information from a host.

In some embodiments, identifying the users comprises observing user usage of the data storage device.

In some embodiments, the method further comprises consolidating pre-programmed data into one of the plurality of metadies.

In yet another embodiment, a data storage device is provided comprising: a plurality of memory dies configured to be organized into a plurality of memory dies; and means for: determining which tenants of a plurality of tenants of the data storage device are frequently used together; assigning tenants of the plurality of tenants that are frequently used together to a same metadie; and accessing memory dies of the same metadie in parallel in response to an access request from one of the tenants that is assigned to the same metadie.

Other embodiments are possible, and each of the embodiments can be used alone or together in combination. Accordingly, various embodiments will now be described with reference to the attached drawings.

### Embodiments

The following embodiments relate to a data storage device (DSD). As used herein, a “data storage device” refers to a non-volatile device that stores data. Examples of DSDs include, but are not limited to, hard disk drives (HDDs), solid state drives (SSDs), tape drives, hybrid drives, etc. Details of example DSDs are provided below.

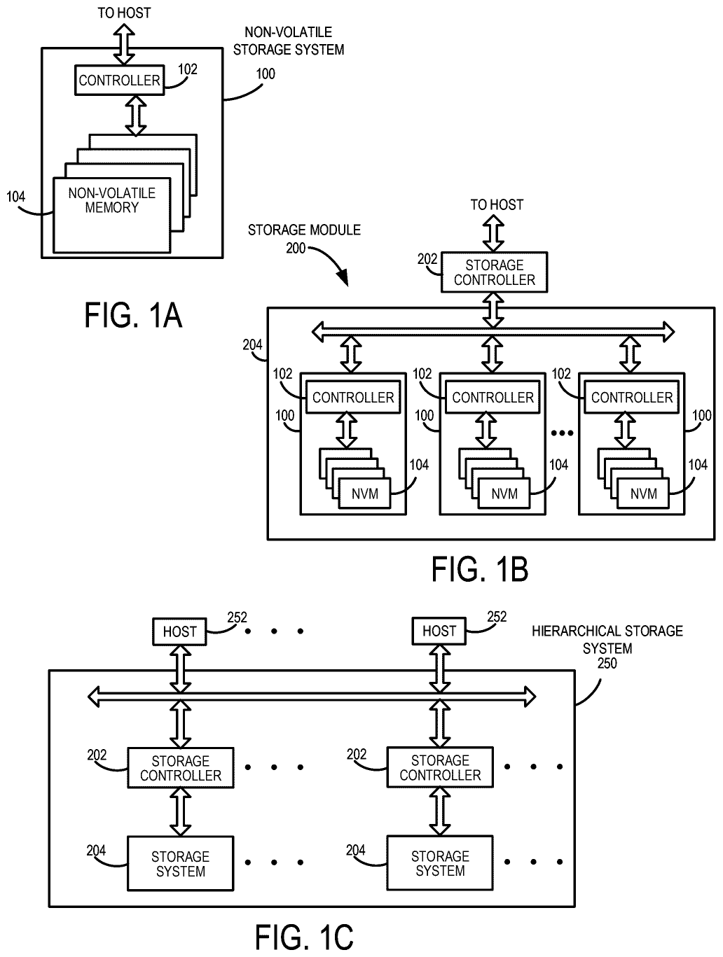

Examples of data storage devices suitable for use in implementing aspects of these embodiments are shown in FIGS. 1A-1C. It should be noted that these are merely examples and that other implementations can be used. FIG. 1A is a block diagram illustrating the data storage device 100 according to an embodiment. Referring to FIG. 1A, the data storage device 100 in this example includes a controller 102 coupled with a non-volatile memory that may be made up of one or more non-volatile memory die 104. As used herein, the term die refers to the collection of non-volatile memory cells, and associated circuitry for managing the physical operation of those non-volatile memory cells, that are formed on a single semiconductor substrate. The controller 102 interfaces with a host system and transmits command sequences for read, program, and erase operations to non-volatile memory die 104. Also, as used herein, the phrase “in communication with” or “coupled with” could mean directly in communication/coupled with or indirectly in communication/coupled with through one or more components, which may or may not be shown or described herein. The communication/coupling can be wired or wireless.

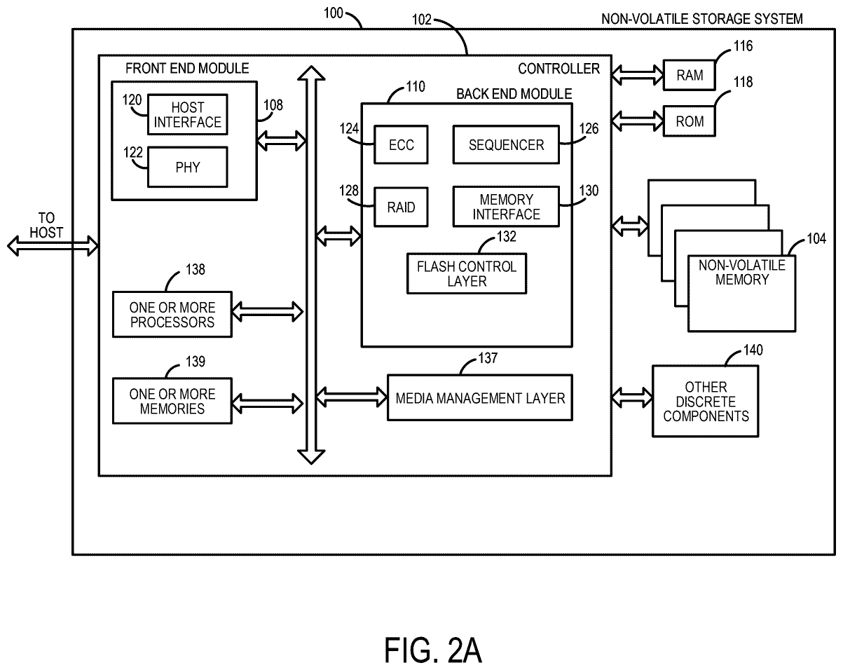

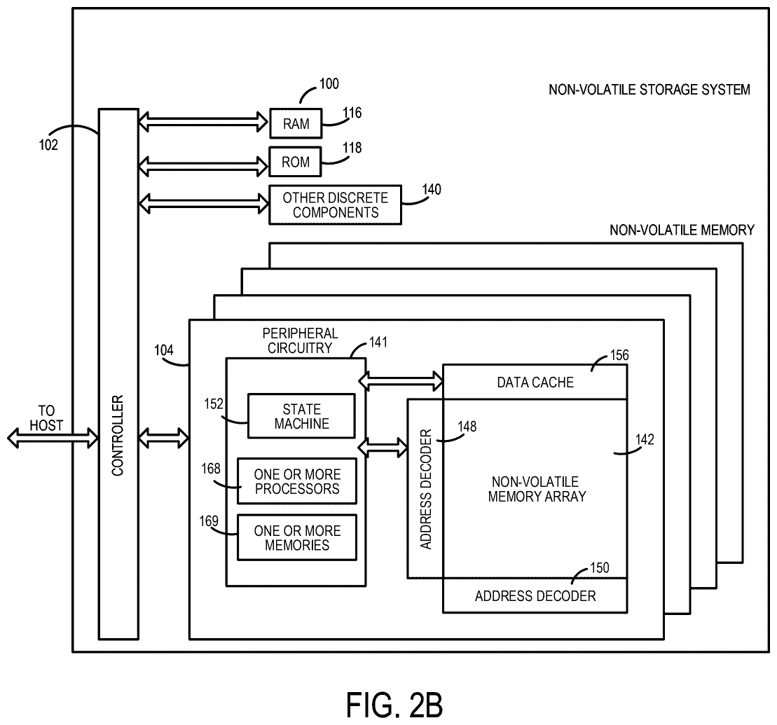

The controller 102 (which may be a non-volatile memory controller (e.g., a flash, resistive random-access memory (ReRAM), phase-change memory (PCM), or magnetoresistive random-access memory (MRAM) controller)) can include one or more components, individually or in combination, configured to perform certain functions, including, but not limited to, the functions described herein and illustrated in the flow charts. For example, as shown in FIG. 2A, the controller 102 can comprise one or more processors 138 that are, individually or in combination, configured to perform functions, such as, but not limited to the functions described herein and illustrated in the flow charts, by executing computer-readable program code stored in one or more non-transitory memories 139 inside the controller 102 and/or outside the controller 102 (e.g., in random access memory (RAM) 116 or read-only memory (ROM) 118). As another example, the one or more components can include circuitry, such as, but not limited to, logic gates, switches, an application specific integrated circuit (ASIC), a programmable logic controller, and an embedded microcontroller.

In one example embodiment, the non-volatile memory controller 102 is a device that manages data stored on non-volatile memory and communicates with a host, such as a computer or electronic device, with any suitable operating system. The non-volatile memory controller 102 can have various functionality in addition to the specific functionality described herein. For example, the non-volatile memory controller can format the non-volatile memory to ensure the memory is operating properly, map out bad non-volatile memory cells, and allocate spare cells to be substituted for future failed cells. Some part of the spare cells can be used to hold firmware (and/or other metadata used for housekeeping and tracking) to operate the non-volatile memory controller and implement other features. In operation, when a host needs to read data from or write data to the non-volatile memory, it can communicate with the non-volatile memory controller. If the host provides a logical address to which data is to be read/written, the non-volatile memory controller can convert the logical address received from the host to a physical address in the non-volatile memory. The non-volatile memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including resistive random-access memory (ReRAM), magnetoresistive random-access memory (MRAM), phase-change memory (PCM), NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC) (e.g., dual-level cells, triple-level cells (TLC), quad-level cells (QLC), etc.) or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, the data storage device 100 may be a card-based system, such as a secure digital (SD) or a micro secure digital (micro-SD) card. In an alternate embodiment, the data storage device 100 may be part of an embedded data storage device.

Although, in the example illustrated in FIG. 1A, the data storage device 100 (sometimes referred to herein as a storage module) includes a single channel between controller 102 and non-volatile memory die 104, the subject matter described herein is not limited to having a single memory channel. For example, in some architectures (such as the ones shown in FIGS. 1B and 1C), two, four, eight or more memory channels may exist between the controller and the memory device, depending on controller capabilities. In any of the embodiments described herein, more than a single channel may exist between the controller and the memory die, even if a single channel is shown in the drawings.

FIG. 1B illustrates a storage module 200 that includes plural non-volatile data storage devices 100. As such, storage module 200 may include a storage controller 202 that interfaces with a host and with data storage device 204, which includes a plurality of data storage devices 100. The interface between storage controller 202 and data storage devices 100 may be a bus interface, such as a serial advanced technology attachment (SATA), peripheral component interconnect express (PCIe) interface, double-data-rate (DDR) interface, or serial attached small scale compute interface (SAS/SCSI). Storage module 200, in one embodiment, may be a solid-state drive (SSD), or non-volatile dual in-line memory module (NVDIMM), such as found in server PC or portable computing devices, such as laptop computers, and tablet computers.

FIG. 1C is a block diagram illustrating a hierarchical storage system. A hierarchical storage system 250 includes a plurality of storage controllers 202, each of which controls a respective data storage device 204. Host systems 252 may access memories within the storage system 250 via a bus interface. In one embodiment, the bus interface may be a Non-Volatile Memory Express (NVMe) or Fibre Channel over Ethernet (FCOE) interface. In one embodiment, the system illustrated in FIG. 1C may be a rack mountable mass storage system that is accessible by multiple host computers, such as would be found in a data center or other location where mass storage is needed.

Referring again to FIG. 2A, the controller 102 in this example also includes a front-end module 108 that interfaces with a host, a back-end module 110 that interfaces with the one or more non-volatile memory die 104, and various other components or modules, such as, but not limited to, a buffer manager/bus controller module that manage buffers in RAM 116 and controls the internal bus arbitration of controller 102. A module can include one or more processors or components, as discussed above. The ROM 118 can store system boot code. Although illustrated in FIG. 2A as located separately from the controller 102, in other embodiments one or both of the RAM 116 and ROM 118 may be located within the controller 102. In yet other embodiments, portions of RAM 116 and ROM 118 may be located both within the controller 102 and outside the controller 102.

Front-end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, serially attached small computer system interface (SAS), Fibre Channel, universal serial bus (USB), PCIe, and NVMe. The host interface 120 typically facilitates transfer for data, control signals, and timing signals.

Back-end module 110 includes an error correction code (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the memory device 104. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. The controller 102 in this example also comprises a media management layer 137 and a flash control layer 132, which controls the overall operation of back-end module 110.

The data storage device 100 also includes other discrete components 140, such as external electrical interfaces, external RAM, resistors, capacitors, or other components that may interface with controller 102. In alternative embodiments, one or more of the physical layer interface 122, RAID module 128, media management layer 138 and buffer management/bus controller are optional components that are not necessary in the controller 102.

FIG. 2B is a block diagram illustrating components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including ReRAM, MRAM, PCM, NAND flash memory cells and/or NOR flash memory cells in a two-dimensional and/or three-dimensional configuration. Non-volatile memory die 104 further includes a data cache 156 that caches data and address decoders 148, 150. The peripheral circuitry 141 in this example includes a state machine 152 that provides status information to the controller 102. The peripheral circuitry 141 can also comprise one or more components that are, individually or in combination, configured to perform certain functions, including, but not limited to, the functions described herein and illustrated in the flow charts. For example, as shown in FIG. 2B, the memory die 104 can comprise one or more processors 168 that are, individually or in combination, configured to execute computer-readable program code stored in one or more non-transitory memories 169, stored in the memory array 142, or stored outside the memory die 104. As another example, the one or more components can include circuitry, such as, but not limited to, logic gates, switches, an application specific integrated circuit (ASIC), a programmable logic controller, and an embedded microcontroller.

In addition to or instead of the one or more processors 138 (or, more generally, components) in the controller 102 and the one or more processors 168 (or, more generally, components) in the memory die 104, the data storage device 100 can comprise another set of one or more processors (or, more generally, components). In general, wherever they are located and however many there are, one or more processors (or, more generally, components) in the data storage device 100 can be, individually or in combination, configured to perform various functions, including, but not limited to, the functions described herein and illustrated in the flow charts. For example, the one or more processors (or components) can be in the controller 102, memory device 104, and/or other location in the data storage device 100. Also, different functions can be performed using different processors (or components) or combinations of processors (or components). Further, means for performing a function can be implemented with a controller comprising one or more components (e.g., processors or the other components described above).

Returning again to FIG. 2A, the flash control layer 132 (which will be referred to herein as the flash translation layer (FTL) handles flash errors and interfaces with the host. In particular, the FTL, which may be an algorithm in firmware, is responsible for the internals of memory management and translates writes from the host into writes to the memory 104. The FTL may be needed because the memory 104 may have limited endurance, may be written in only multiples of pages, and/or may not be written unless it is erased as a block. The FTL understands these potential limitations of the memory 104, which may not be visible to the host. Accordingly, the FTL attempts to translate the writes from host into writes into the memory 104.

The FTL may include a logical-to-physical address (L2P) map (sometimes referred to herein as a table or data structure) and allotted cache memory. In this way, the FTL translates logical block addresses (“LBAs”) from the host to physical addresses in the memory 104. The FTL can include other features, such as, but not limited to, power-off recovery (so that the data structures of the FTL can be recovered in the event of a sudden power loss) and wear leveling (so that the wear across memory blocks is even to prevent certain blocks from excessive wear, which would result in a greater chance of failure).

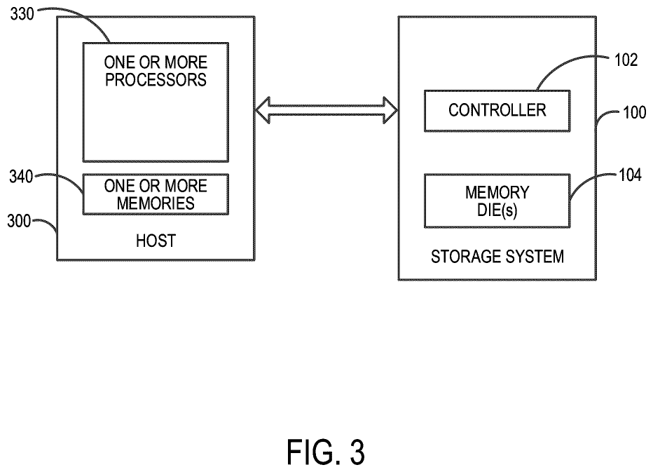

Turning again to the drawings, FIG. 3 is a block diagram of a host 300 and data storage device 100 of an embodiment. The host 300 can take any suitable form, including, but not limited to, a computer, a mobile phone, a tablet, a wearable device, a digital video recorder, a surveillance system, etc. The host 300 in this embodiment (here, a computing device) comprises one or more processors 330 and one or more memories 340. In one embodiment, computer-readable program code stored in the one or more memories 340 configures the one or more processors 330 to perform, individually or in combination, the acts described herein as being performed by the host 300. So, actions performed by the host 300 are sometimes referred to herein as being performed by an application (computer-readable program code) run on the host 300. For example, the host 300 can be configured to send data (e.g., initially stored in the host's memory 340) to the data storage device 100 for storage in the data storage device's memory 104.

Multiple memory dies, which can operate in parallel (within an allowed power budget), can be logically grouped together by the controller 102 (e.g., the flash translation later (FTL)). Traditional, low-capacity data storage devices can have relatively-fewer memory dies, and all of them can operate in parallel. Hence, these data storage devices can have only a single logical die grouping covering all of the memory dies. However, relatively-larger capacity data storage devices can have a greater number of memory dies than the maximum power allowed. For example, storage products of four terabytes (TB), eight TB, and higher capacities are becoming the standard, and higher storage capacity products can have a relatively-large number of memory dies (e.g., 32, 64, 128 etc.). Due to power limitations enforced by the host/host protocols, not all of the memory dies may be operated in parallel. Additionally, many data storage devices do not have enough resources (e.g., RAM, queues, etc.) for all memory dies in a higher-capacity system, so not all memory dies may be activated in parallel. Memory dies that are allowed to work in parallel are logically grouped together as a “metadie.” A single metadie would not cover all of the memory dies in the data storage device in this situation. Hence, the data storage device would have multiple metadies. In some situations, a metadie is the maximum number of memory dies that can operate in parallel.

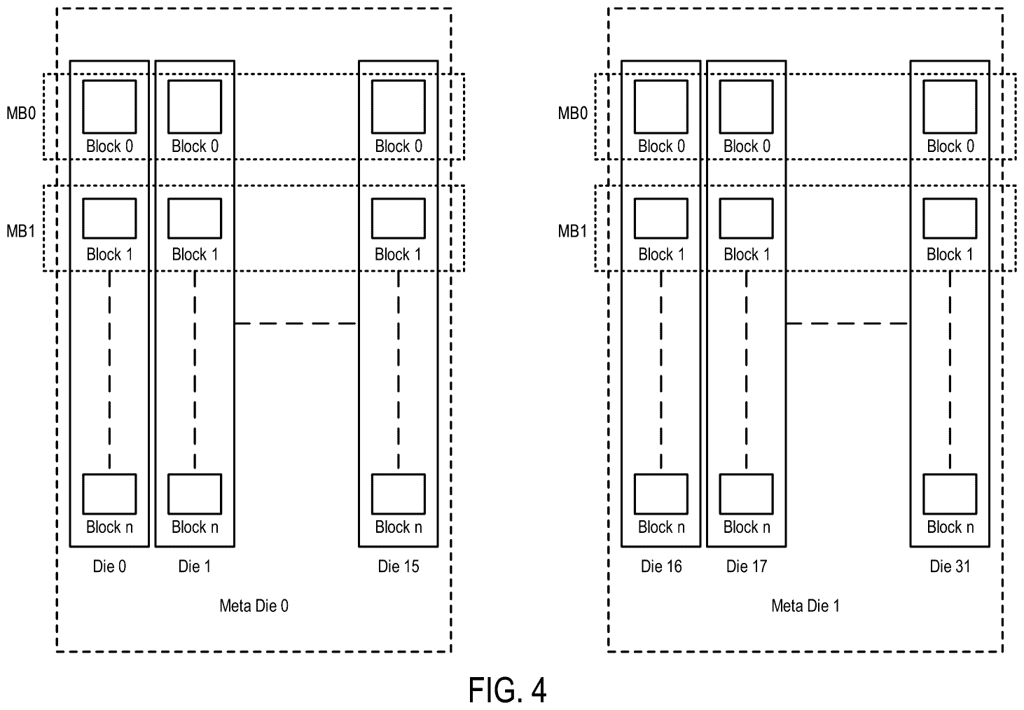

FIG. 4 illustrates an example of the use of multiple metadies of an embodiment. In this example, the data storage device comprises 32 memory dies, and the maximum number of memory dies allowed to work simultaneously due to power restrictions is 16 memory dies. So, a metadie comprises 16 memory dies in this example, and the data storage device has two metadies. Also, as shown in FIG. 4, a metablock comprises blocks from a plurality of dies from each metadie. Metablocks can exist on every metadie, and the controller 102 (e.g., the FTL) can function using a solitary metablock from one of the metadies during a program or sequential read operation (i.e., so only one metadie would be active).

The controller 102 can switch metablocks from one metadie to another metadie; however, there may be overhead associated with such switching. So, by design, switching between metadies can be minimized and done at a metablock boundary (e.g., with the metablock gets full). Whenever the controller 102 switches a metadie (e.g., to metadie 1 from metadie 0), there can be associated overhead. For example, if the data storage device lack sufficient resources (e.g., RAM for relink tables and other data structures such as a group allocation table (GAT), as well as various queues within the data path), switching metadies can require writing the current metadie's RAM data to the non-volatile NAND memory and loading previous state data into the RAM for the new metadie (e.g., a “swap-in/swap-out” operation). These operations can induce delays in the system. Another overhead is the inability to use NAND performance features. For example, if operations continue in the same physical dies (i.e., in the same metadie), performance features (such as write cache, read cache, and suspend resume) can be used to hide the transfer time. These features provide sizeable performance gains. However, as metadies operate on different physical dies, these features cannot be used while switching metadies.

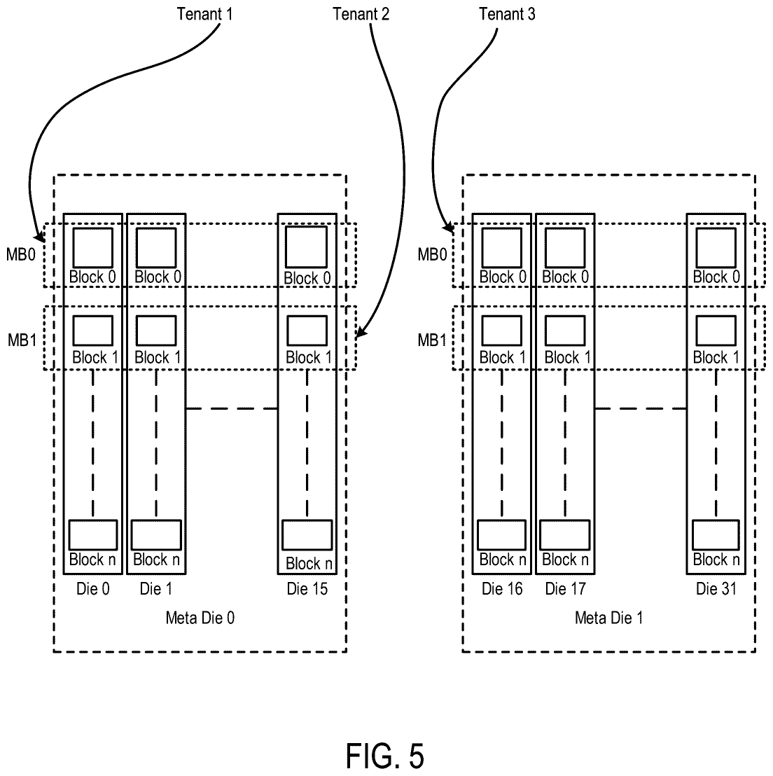

Another issue relates to multitenancy, which refers to the ability of the data storage device to efficiently support multiple independent users/tenants. Tenants with various characteristics can be created in the data storage device. In many cases, tenants can share memory dies, and different metablocks can be attached to different tenants. There can be multiple tenants attached to a data storage device, and each tenant can be allocated some unique space (e.g., in logical terms, a few metablocks) in the data storage device. To simplify the explanation, the data storage device has three tenants in the example shown in FIG. 5. If, behaviorally, Tenant 1 and Tenant 3 operate together frequently (e.g., operate together more than a threshold number of times), the controller of the data storage device would need to switch between metadies (e.g., MD0->MD1->MD0->MD1, etc.). This frequent switching of metadies can consistently face all the previously-stated overheads and can cause significant performance degradation of the data storage device.

The following embodiments can be used to place, on the same metadie, tenants that are frequently used together. This can reduce metadie switching overhead and, hence, increase overall device performance. By keeping tenants that operate together frequently on the same metadie, the controller of the data storage device can activate only one metadie at any point of time. Placing these tenants on same metadie can avoid the metadie switching overheads discussed above.

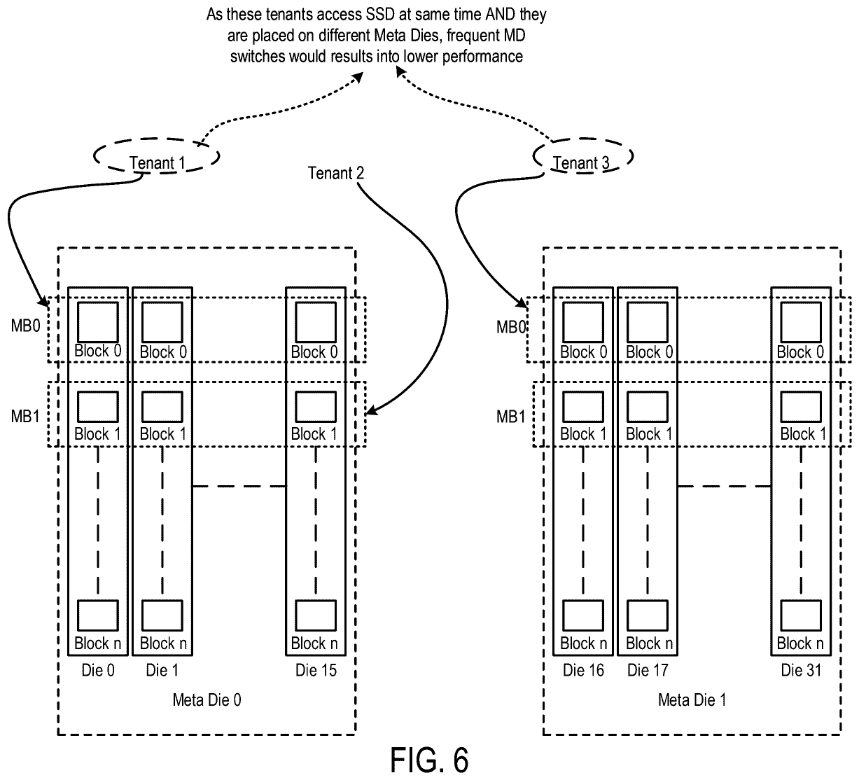

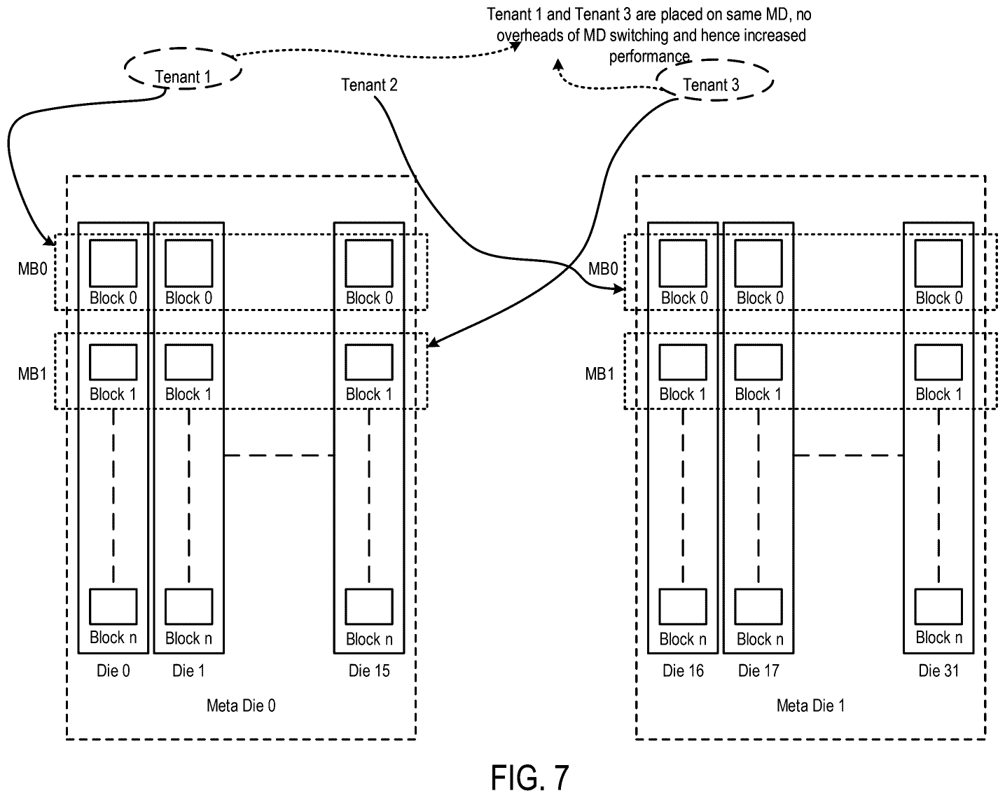

Turning again to the drawings, FIG. 6 is an illustration of two tenants (Tenant 1 and Tenant 2) frequently accessing different metadies of a data storage device at the same time. As these tenants access the data storage device at the same time and they are placed on different metadies, frequent metadie switching can result in lower performance. In contrast, when Tenant 1 and Tenant 2 are placed on the same metadie (see FIG. 7), the overhead of metadie switching is avoided, and performance is increased.

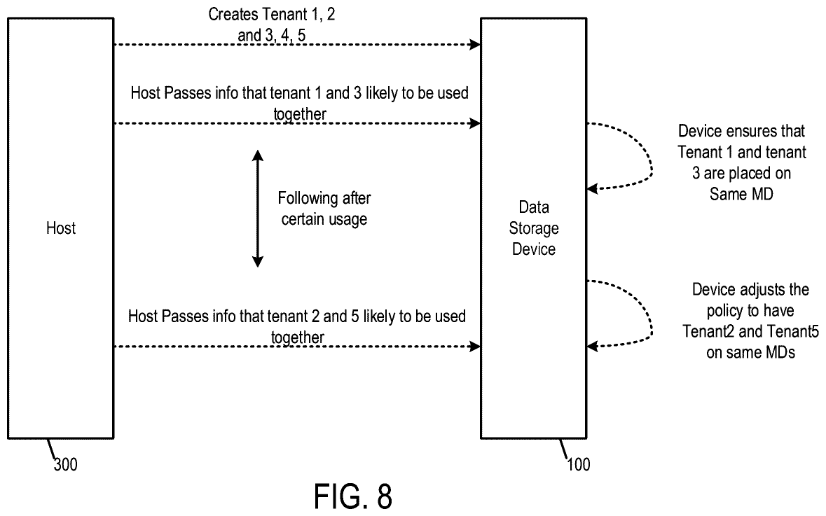

Any suitable technique can be used to identify tenants that frequently operate together. For example, the host 300 can assist with tenant grouping. In this example, the host 300 can monitor/identify the information about tenants getting activated at same time. This information about tenants can be passed while creating the tenants or with usage as the host 300 learns which tenants get activated together. This is illustrated in FIG. 8. As shown in FIG. 8, the host 300 creates Tenants 1-5 and sends information to the data storage device 100 indicating that Tenants 1 and 3 are likely to be used together. In response, the controller 102 of the data storage device 100 ensures that Tenants 1 and 3 are placed on the same metadie. After a certain amount of usage, the host 300 can update the information as needed. Here, the host 300 informs the data storage device 100 that Tenants 2 and 5 are likely to be used together, and, in response, the controller 102 of the data storage device 100 ensures that Tenants 2 and 5 are placed on the same metadie.

As another example, the controller 102 of the data storage device 100 can identify tenants that frequently operate together by learning tenant behavioral usage. In this example, the controller 102 can sample and track how tenants are issuing loads to the data storage device 100. Based on that information, the tenant's metadie location can be selected. While utilizing this approach, the controller does not have to immediately detect tenant usage, as a certain amount of time may be needed before making a decision. Additionally, pre-programmed data can be gradually consolidated into a unified metadie.

Finally, as mentioned above, any suitable type of memory can be used. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are examples, and memory elements may be otherwise configured.

The semiconductor memory elements located within and/or over a substrate may be arranged in two or three dimensions, such as a two-dimensional memory structure or a three-dimensional memory structure.

In a two-dimensional memory structure, the semiconductor memory elements are arranged in a single plane or a single memory device level. Typically, in a two-dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and wordlines.

A three-dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three-dimensional memory structure may be vertically arranged as a stack of multiple two-dimensional memory device levels. As another non-limiting example, a three-dimensional memory array may be arranged as multiple vertical columns (e.g., columns extending substantially perpendicular to the major surface of the substrate, i.e., in the y direction) with each column having multiple memory elements in each column. The columns may be arranged in a two-dimensional configuration, e.g., in an x-z plane, resulting in a three-dimensional arrangement of memory elements with elements on multiple vertically stacked memory planes. Other configurations of memory elements in three dimensions can also constitute a three-dimensional memory array.

By way of non-limiting example, in a three-dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three-dimensional configurations can be envisioned wherein some NAND strings contain memory elements in a single memory level while other strings contain memory elements which span through multiple memory levels. Three-dimensional memory arrays may also be designed in a NOR configuration and in a RcRAM configuration.

Typically, in a monolithic three-dimensional memory array, one or more memory device levels are formed above a single substrate. Optionally, the monolithic three-dimensional memory array may also have one or more memory layers at least partially within the single substrate. As a non-limiting example, the substrate may include a semiconductor such as silicon. In a monolithic three-dimensional array, the layers constituting each memory device level of the array are typically formed on the layers of the underlying memory device levels of the array. However, layers of adjacent memory device levels of a monolithic three-dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three-dimensional memory arrays. Further, multiple two-dimensional memory arrays or three-dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three-dimensional structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

1. A data storage device comprising:
a volatile memory;
a plurality of memory dies; and
one or more processors configured to:
create a plurality of metadies, wherein each metadie comprises a different subset of memory dies of the plurality of memory dies;
receive information from a host regarding tenants that are created at same time by the host, which is indicative that the tenants will be frequently used together;
assign the tenants to one of the plurality of metadies;
process memory access requests from the tenants without switching metadies. which avoids swapping state data in and out of the volatile memory when metadies are switched;
track memory access requests from other tenants over an amount of time, wherein processing of the memory access requests from other tenants requires switching metadies, which involves swapping state data in and out of the volatile memory: and
after the amount of time has passed:
determine which ones of the other tenants operate together more than a threshold number of times; and
assign the ones of the other tenants that operate together more than the threshold number of times to another one of the plurality of metadies; and
process memory access requests from the ones of the other tenants without switching metadies, which avoids swapping state data in and out of the volatile memory when metadies are switched;
wherein the one or more processors comprises (i) a plurality of processors configured individually or in combination or (ii) a single processor

2. (canceled)

3. The data storage device of claim 1, wherein the one or more processors are further configured to determine which tenants are frequently used together by receiving tenant grouping information from a host.

4. The data storage device of claim 3, wherein the tenant grouping information is created by the host when the host creates the tenants.

5. The data storage device of claim 3, wherein the tenant grouping information is created by the host over time as the host observes which tenants are frequently used together.

6. The data storage device of claim 1, wherein the one or more processors are further configured to receive updated tenant grouping information from the host.

7. The data storage device of claim 1, wherein the one or more processors are further configured to determine which tenants are frequently used together by observing tenant usage.

8. The data storage device of claim 1, wherein the one or more processors are further configured to consolidate pre-programmed data into one of the plurality of metadies.

9. The data storage device of claim 1, wherein a power limitation prohibits all of the memory dies of the plurality of memory dies from being grouped together as a single metadie.

10. The data storage device of claim 1, wherein a resource limitation prohibits all of the memory dies of the plurality of memory dies from being grouped together as a single metadie.

11. The data storage device of claim 1, wherein the plurality of memory dies comprises at least 16 memory dies.

12. The data storage device of claim 1, wherein the plurality of memory dies comprises at least 32 memory dies.

13. The data storage device of claim 1, wherein the plurality of memory dies comprises at least 64 memory dies.

14. The data storage device of claim 1, wherein the plurality of memory dies comprises at least 128 memory dies.

15. The data storage device of claim 1, wherein at least one memory die of the plurality of memory dies comprises a three-dimensional memory.

16. A method comprising:
performing in a data storage device comprising a volatile memory and a plurality of memory dies organized into a plurality of metadies:
receiving information from a host regarding tenants that are created at same time by the host, which is indicative that the tenants will be frequently used together;
assigning the tenants to one of the plurality of metadies;
processing memory access requests from the tenants without switching metadies. which avoids swapping state data in and out of the volatile memory when metadies are switched;
tracking memory access requests from other tenants over an amount of time wherein processing of the memory access requests from other tenants requires switching metadies, which involves swapping state data in and out of the volatile memory; and
after the amount of time has passed:
determining which ones of the other tenants operate together more than a threshold number of times; and
assigning the ones of the other tenants that operate together more than the threshold number of times to another one of the plurality of metadies; and
processing memory access requests from the ones of the other tenants without switching metadies, which avoids swapping state data in and out of the volatile memory when metadies are switched.

17. The method of claim 16, further comprising receiving tenant grouping information from a host.

18. The method of claim 16, further comprising observing tenant usage of the data storage device.

19. The method of claim 16, further comprising consolidating pre-programmed data into one of the plurality of metadies.

20. A data storage device comprising:
a volatile memory;
a plurality of memory dies configured to be organized into a plurality of metadies, and means for:
receiving information from a host regarding tenants that are created at same time by the host, which is indicative that the tenants will be frequently used together:
assigning the tenants to one of the plurality of metadies;
processing memory access requests from the tenants without switching metadies which avoids swapping state data in and out of the volatile memory when metadies are switched;
tracking memory access requests from other tenants over an amount of time. wherein processing of the memory access requests from other tenants requires switching metadies, which involves swapping state data in and out of the volatile memory; and
after the amount of time has passed:
determining which ones of the other tenants operate together more than a threshold number of times; and
assigning the ones of the other tenants that operate together more than the threshold number of times to another one of the plurality of metadies; and
processing memory access requests from the ones of the other tenants without switching metadies, which avoids swapping state data in and out of the volatile memory when metadies are switched.
